(19) United States
(12) Patent Application Publication
(10) Pub. No.: US 2013/0061009 A1
(43) Pub. Date: Mar. 7, 2013

(54) High Performance Free Buffer Allocation and Deallocation

(71) Applicants: Sailesh Kumar, San Jose, CA (US); William Lynch, Los Altos, CA (US)

(72) Inventors: Sailesh Kumar, San Jose, CA (US); William Lynch, Los Altos, CA (US)

(73) Assignee: FUTUREWEI TECHNOLOGIES, INC., Plano, TX (US)

(21) Appl. No.: 13/598,279

(22) Filed: Aug. 29, 2012

Related U.S. Application Data
(60) Provisional application No. 61/531,352, filed on Sep. 6, 2011.

(51) Int. Cl. G06F 12/02

(52) U.S. Cl. 711/154; 711/E12.002

(57) ABSTRACT

The disclosure includes an apparatus comprising a memory configured to store a free list comprising a plurality of nodes, wherein at least one of the plurality of nodes is configured to store a plurality of node addresses, and wherein each of the plurality of node addresses corresponds to one node in the plurality of nodes. The disclosure further includes a method of memory management comprising using a free list comprising a plurality of nodes and storing a plurality of node addresses in at least one of the plurality of nodes, and wherein each of the plurality of node addresses corresponds to one node in the plurality of nodes.

### CROSS-REFERENCE TO RELATED APPLICATIONS

The present application claims priority to U.S. Provisional Patent Application No. 61/531,352 filed Sep. 6, 2011 by Sailesh Kumar et al. and entitled “High Performance Free Buffer Allocation and Deallocation”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In a processor system, memory bandwidth is a precious resource as it may directly translate into system performance and cost. Therefore, memory (e.g., buffer) management capabilities are usually included in modern processor systems. In use, a running application in a processor may send a request to a memory controller or management unit, which may then allocate a memory space of a certain size to the application. When the application no longer needs the memory space, the memory management unit may deallocate or free the memory space for future use. In practice, memory management may be one of the most common functions in a networking hardware system and/or software feature to provide, e.g. high performance packet processing. To implement memory management, various algorithms and data-structures may be used to reduce a required memory bandwidth to fulfill a certain feature.

### SUMMARY

In one embodiment, the disclosure includes an apparatus comprising a memory configured to store a free list comprising a plurality of nodes, wherein at least one of the plurality of nodes is configured to store a plurality of node addresses, and wherein each of the plurality of node addresses corresponds to one node in the plurality of nodes.

In another embodiment, the disclosure includes a method of memory management comprising using a free list comprising a plurality of nodes and storing a plurality of node addresses in at least one of the plurality of nodes, and wherein each of the plurality of node addresses corresponds to one node in the plurality of nodes.

In yet another embodiment, the disclosure includes an apparatus comprising a memory configured to store a free list, wherein the free list comprises a plurality of nodes including a first pointer node, a second pointer node, and a set of non-pointer nodes, wherein the first pointer node is configured to store a set of node addresses, wherein one of the set of node addresses points to the second pointer node, and wherein the rest of the set of node addresses point to corresponding ones of the set of non-pointer nodes, a processor coupled to the memory and configured to generate an allocation request, and a memory management unit coupled to the memory and configured to store identifying information of the free list, wherein the identifying information comprises a node address of the first pointer node, in response to the allocation request, remove the first pointer node and the corresponding ones of the set of non-pointer nodes from the free list by changing the node address of the first pointer node to a node address of the second pointer node, and store the node address of the first pointer node and the rest of the set of node addresses in a local buffer.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a traditional memory management scheme using a free list.

FIG. 2 is a schematic diagram of an embodiment of a processor system.

FIG. 3 is a schematic diagram of an embodiment of a free list-based memory management scheme.

FIG. 4 is a flowchart of an embodiment of a memory management method.

FIG. 5 is a schematic diagram of an embodiment of a network unit.

FIG. 6 is a schematic diagram of a general-purpose computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

There are a variety of data structures used for memory management today, including free lists, buddy blocks, bit vectors, etc. Specifically, a free list is a data structure used for dynamic memory allocation and deallocation. In a free list-based memory management scheme, free or unused memory may be organized in units of blocks, which also be referred to herein as nodes. Each node represents a small region (e.g., 32 bytes, 1K bytes, etc.) of memory. Further, each node may be divided into a plurality of sections or parts of equal size. Since one or more of the sections may store node address(es) pointing to other node(s), a section size may depend on a length of a node address. For example, if each node address in the system has 4 bytes (4B), then the size of each section may be determined to be 4B to accommodate the address size.

In use, as any node in a memory pool may become a free node, one or more node addresses may be stored in one or more sections of each node. The node address(es) may point or correspond to another node, thus nodes of free memory may be interlinked together to form the free list.

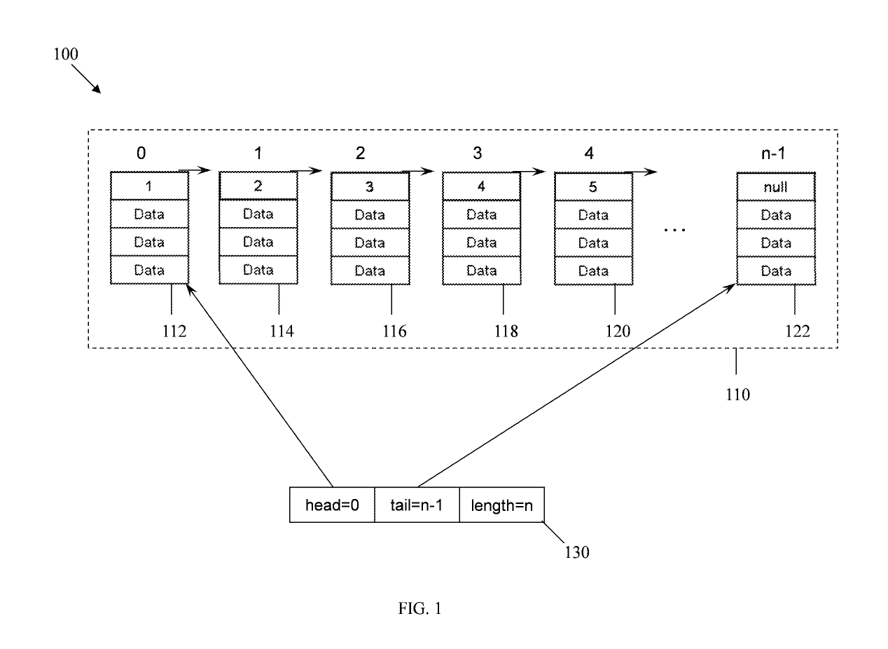

FIG. 1 illustrates a traditional memory management scheme 100 using a free list 110. The free list 110 comprises n nodes, where n is a positive integer, such as nodes 112, 114, 116, 118, 120, and 122. In use, as any node in a memory pool may become a free node, a first section of each node is configured to store a node address (also referred to as a pointer) pointing to another node of the free list 110. For example, a first section of the node 112 with index 0 (head of the free list 110) contains a node address pointing to the node 114 with index 1. Similarly, a first section of the node 118 with index 3 contains a node address pointing to the node 120 with index 4. The node 122 is a last node or tail of the free list 110, thus it may contain a null address. By storing one node address in each node, all nodes may be sequentially linked to form the free list 110. All nodes of the free list 110 are pointer nodes, and each node contains one pointer.

In addition, identifying information 130 may be stored in a memory management unit and used by the traditional memory management scheme 100 to identify the free list 110. Such information may include at least two of the three parameters including head, tail, and length of the free list 110. In the traditional memory management scheme 100, to allocate a node to a processor, the node 112 (i.e., the head) may simply be removed from the free list 110. Removal of the node 112 may be realized by updating head and length of the identifying information 130. For example, the node address of the node 114 (i.e., second node) may be read from the node 112. Then, head information in the identifying information 130 may be changed from the node 112 with index 0 to the node 114 with index 1, and length information may be reduced by one. On the other hand, when the processor no longer needs a node, the traditional memory management scheme 100 may deallocate the node by adding it behind the tail of the free list 110. Addition of a node may be realized by updating tail and length of the identifying information 130.

The traditional memory management scheme 100 may allocate and deallocate memory by removing and adding a node to the free list 110. These operations may be relatively simple compared to other data structures. However, in the traditional memory management scheme 100, only one section in each node is utilized to store a node address, and other sections are left unused. Consequently, each allocation request may only remove one node from the free list 110, and each deallocation request may only add one node from the free list 110. In other words, allocation and deallocation of multiple nodes may require multiple requests from the processor. Thus, with the free list 110 constructed as is in the traditional memory management scheme 100, it may be difficult to reduce the memory bandwidth required to allocate and de-allocate multiple nodes.

Disclosed herein are systems and methods for improved memory allocation and deallocation. In a disclosed memory management scheme, the data structure of a free list is modified compared to a traditional free list. The disclosed free list comprises one or more pointer nodes and a plurality of non-pointer nodes. Each pointer node is configured to store a plurality of node addresses or pointers. In an embodiment, one of the plurality of node addresses points to a next pointer node in a pointer chain of the free list, while rest of the plurality of node addresses point to a set of non-pointer nodes. The set of non-pointer nodes may not contain any node address, however each non-pointer in the set may be located based on its corresponding node address stored in the pointer node. In the present disclosure, a plurality of nodes may be allocated (or deallocated) with a single allocation (or deallocation) request. In an embodiment, with a read operation in a memory, one pointer node as well as a set of non-pointer nodes indicated by the pointed node may be allocated. Similarly, with a write operation in the memory, one pointer node as well as its pointed set of non-pointer nodes may be deallocated. Further, identifying information of the free list, such as a head, tail, and/or length, may also be used in a memory management module to facilitate memory allocation and deallocation. In comparison with a traditional memory management scheme using a free list, a disclosed memory management scheme may require no additional memory space. At the same time, the disclosed memory management scheme may bring about various benefits such as reducing a bandwidth requirement, improving system throughput, and lowering memory latency.

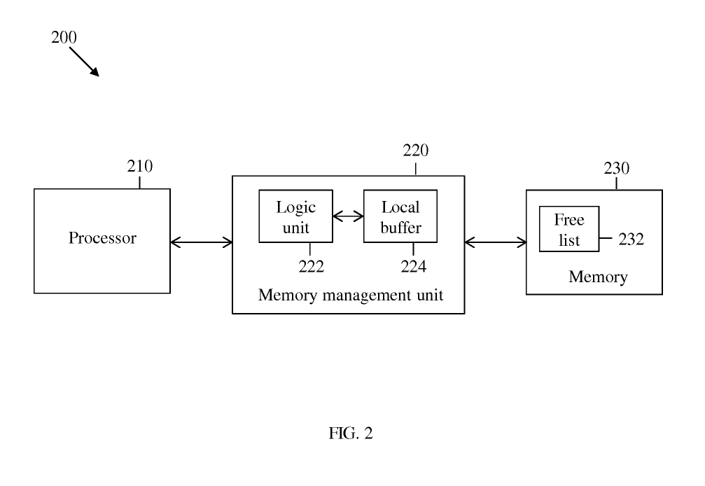

FIG. 2 illustrates an embodiment of a processor system 200, wherein a disclosed memory management scheme may be implemented. The processor system 200 comprises a processor 210, a memory controller or management unit 220, and a memory 230 arranged as shown in FIG. 2. The processor 210 may generate various requests to access the memory 230 via the memory management unit 220. A request may be generated by an application or program running in the processor 210. When a memory region of certain size is requested by the application, the request may be referred to as an allocation request. Otherwise, when a memory region of certain size is no longer used by the application and being released for future use, the request may be referred to as a deallocation request. The request may contain information such as a size of memory region to be allocated or deallocated. The processor 210 may send the request to the memory management unit 220, which may then allocate or deallocate the memory region based on the request.

Although illustrated as a single processor, the processor 112 is not so limited and may comprise a plurality of processors. For example, the processor 112 may be implemented as one or more central processor unit (CPU) chips, cores (e.g., a multi-core processor), field-programmable gate arrays (FPGAs), application specific integrated circuits (ASICs), and/or digital signal processors (DSPs), and/or may be part of one or more ASICs. In practice, if the processor 120 comprises a plurality of cores, a request may be generated and sent by any of the plurality of cores. In addition, the processor 210 may be a network-based processor such as a router, switch, data-center equipment, and gateway GPRS (general packet radio service) support node (GGSN) device.

The memory management unit 220 may process allocation and deallocation requests received from the processor 210. In an embodiment, the memory management unit 220 comprises a logic unit 222 and a local buffer 224. The logic unit 222 may receive request from the processor 210, and make a logic decision to allocate or deallocate a memory space. The local buffer 224 may be used for temporary storage of data which are frequently accessed by the logic unit 222. For instance, in memory allocation, the local buffer 224 may store node addresses read from a node which has been removed from a free list. In memory deallocation, the local buffer 224 may store node addresses pointing to nodes, which are to be added to the free list. The local buffer 224 may reside on a same chip (i.e., on-chip) with the logic unit 222. In addition, the logic unit 222 may reside on a same or different chip with the processor 210 and/or the memory 230.

At least one free list 232 may be stored in the memory 230. The free list 232 may be managed by the memory management unit 220, thus identifying information of the free list 232 may be stored in the memory management unit 220, e.g., in the local buffer 224. The free list 232 will be further described in paragraphs below.

In use, the memory 230 may be any form or type of memory. In an embodiment, the memory 230 is a buffer or a cache. In this case, the memory management unit 220 may be referred to as a buffer management unit or a cache management unit. In terms of location, the memory 230 may be an on-chip memory (i.e., on a same physical chip with the processor 210), such as a cache, special function register (SFR) memory, internal random access memory (RAM), or an off-chip memory, such as an external SFR memory, external RAM, hard drive, universal serial bus (USB) flash drive, etc. Further, if desired, a single memory chip may be divided into a plurality of parts or regions, and each region may be used as a separate smaller memory. Alternatively, if desired, a plurality of memory chips may be used in combination as a single larger memory. Thus, a disclosed memory management scheme may be performed within a single memory chip or across multiple memory chips.

An interconnect between the processor 210 and the memory management unit 220 may be any communication channel or switching fabric/switch which facilitates data communication. In practice, the interconnect may take a variety of forms, such as one or more buses, crossbars, unidirectional rings, bidirectional rings, etc. Likewise, an interconnect between the memory management unit 220 and the memory 230 may also be any communication channel. In the event that the processor 210 and the memory management unit 220, or the memory management unit 220 and the memory 230 are at different locations, the interconnect may take form of a network channel, which may be any combination of routers and other processing equipment necessary to transmit signals between the processor 210 and the memory management unit 220, or between the memory management unit 220 and the memory 230. The interconnect may, for example, be the public Internet or a local Ethernet network.

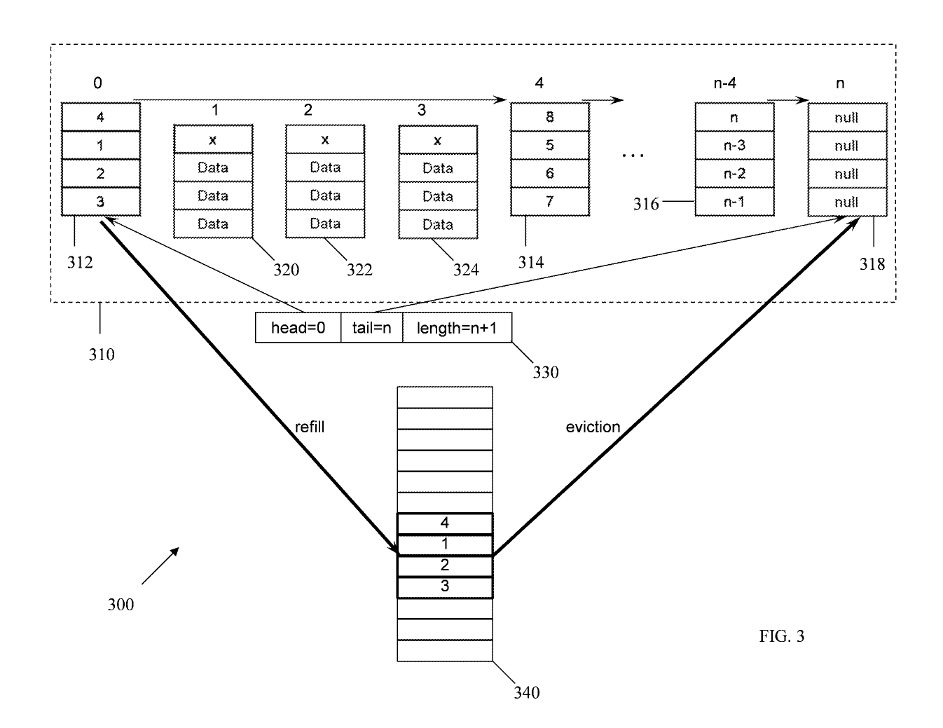

FIG. 3 illustrates an embodiment of a free list-based memory management scheme 300, which may be implemented in a processor system (e.g., the processor system 200 in FIG. 2). In the memory management scheme 300, a free list 310 may comprise one or more pointer nodes, such as pointer nodes 312, 314, 316, and 318, which contain node addresses pointing to other nodes. As shown in FIG. 3, the pointer nodes may be sequentially linked to one another, thereby forming a pointer chain. The free list 310 may further comprise a plurality of non-pointer nodes, such as non-pointer nodes 320, 322, and 324, which contain no address pointing to any other node(s). In an embodiment, each pointer node is configured to store a plurality of node addresses. Each node address points or corresponds to one pointer or non-pointer node of the free list 310. On the other hand, non-pointer nodes may contain no node addresses, thus they may not be part of the pointer chain. However, all non-pointer nodes may be located via the pointers stored in the pointer nodes in the pointer chain.

As an example, the free list 310 comprises a total of (n+1) nodes, where n is a positive integer. For the purpose of illustration, each node is labeled by an index ranging from 0 to n. In the free list 310, the pointer node 312 is a first node with index 0 (also referred to as a head), and the pointer node 318 is a last node with index n (also referred to as a tail). Each pointer node in the free list 310 comprises four sections, and each section is configured to store one node address. For instance, the pointer node 312, whose address is simply labeled by its index 0, may store four node addresses labeled as 1, 2, 3, and 4. A first section of the node 312 may store the node address 4, which points to the pointer node 314, while other sections of the node 312 may store the node addresses 1, 2, and 3, which points to the non-pointer nodes 320, 322, and 324 respectively.

Similarly, other pointer nodes of the free list 310 may also be configured to store four node addresses, e.g., the pointer node 316 with an index of 4 may store four node addresses pointing to one pointer node (with index 8) and three non-pointer nodes (with indexes 5, 6, and 7). Nevertheless, the last pointer node 318 with index n may be configured differently, since it may not point to any additional node. The last pointer node 318 may be configured to contain null addresses or no address. It should be noted that, depending on an addressing scheme used by the processor system, the node addresses stored in a pointer node, such as the pointer node 312, may be either physical or virtual addresses.

Although each pointer node in FIG. 3 is divided into four sections, and each section stores one node address, it should be understood that in the present disclosure a pointer node may contain any number of sections greater than one. Consequently, each pointer node may be configured to point to any number of nodes (i.e., not necessarily four nodes). Further, although all sections of the node 312 contain a node address, if desired, some of its sections may be left empty or contain other types of data. In other words, a number of node addresses stored in a pointer node may be smaller than a number of sections in the pointer node. Moreover, although the first section of the pointer node 312 is used to store the node address (labeled as 4) pointing to the pointer node 314, if desired, the node address 4 may be stored in any other section of the pointer node 312.

The free list 310 may be stored in a memory (e.g., the memory 230 in FIG. 2). Meanwhile, identifying information 330 of the free list 310 may be stored in a memory controller or management unit (e.g., the memory management unit 220). Identifying information 330 may be used to identify or locate the free list 310, therefore such information may include at least two of the three parameters including head, tail, and length of the free list 310. For example, if addresses of the pointer nodes 312 (i.e. head) and 318 (i.e., tail) are known, the free list may be identifiable by the memory management unit.

In an embodiment, when a processor (e.g., the processor 210) generates an allocation request for a memory space, the memory management unit may allocate the memory space to the processor by removing a plurality of nodes from the free list 310 at one time. For example, with one single read operation performed in the memory to read the contents of the pointer node 312, the pointer node 312 (i.e., the head) and a number of non-pointer nodes 320, 322, and 324, which are pointed to by the pointer node 312 may be allocated together to the processor. Removal of the plurality of nodes from the free list 310 may be realized by updating the identifying information 330. In an embodiment, the memory management unit may send a read request to the memory to access the node 312 for all stored addresses. The address pointing to the node 314 with index 4 may be updated in the identifying information 330 as a new head of the free list 310. Further, if length information is used in the identifying information 330, the length of the free list 310 may be reduced by four (provided that the free list 310 has at least eight nodes).

After being allocated to the processor, the nodes 312, 320, 322, and 324 may no longer be part of the free list 310. Instead, these nodes may be utilized by the processor to store various types of data. In some cases, whether the nodes are free or used by the processor, a first of the four sections in each node may be reserved for storage of a node address pointing to another node, while the other three sections may be used for storage of any type of data. In other cases, after the nodes are allocated, all four sections of each node may be available for storage of any type of data. It should be noted that, when non-pointers nodes (e.g., the node 320) are part of the free list 310, they may be empty or contain any type of data, since the content stored in the non-pointer nodes may not affect functioning of the free list 310.

In an embodiment, when the processor no longer needs a memory space, it may send a deallocation request to the memory management unit to deallocate (or release, or recycle) the memory space for future use. The memory management unit may then add a plurality of nodes to the free list 310 at one time. For example, with one write operation performed in the memory, a plurality of grouped or packed nodes may be added to the free list 310. To add the plurality of nodes, the memory management unit may send a write request to memory to access the free list 310. A plurality of node addresses pointing to the nodes may be written into sections of the node 318 (i.e., the tail). Additionally, the identifying information 330 may be updated in the memory management unit. In an embodiment, the tail of the free list 310 may be changed from the pointer node 318 to a new pointer node (e.g., the pointer node 314 previously removed from the free list 310), and the length of the free list 310 may increase by four.

As shown in FIG. 3, if the node 312 is removed from the free list 310, four node addresses pointing to the pointer node 312 and the non-pointer nodes 320, 322, and 324 may be temporarily stored in a local buffer 340. Thus, the local buffer 340 may be refilled after each allocation request. A minimum size of the local buffer 340 may be configured to equal a number of node addresses contained in a single pointer node. Since each pointer node in the free list 310 is illustrated to include four node addresses, the minimum size of the local buffer 340 may hold just four node addresses. In practice, requests from the processor may arrive in spurts or an uneven pattern. Thus, to absorb some burstiness of requests, the minimum size of the local buffer 340 may also be configured to equal two times the size of a pointer node, i.e., holding eight node addresses as shown in FIG. 3. The local buffer 340 may be the same with or similar to the local buffer 224 in FIG. 2.

The local buffer 340 may also facilitate the deallocation of nodes. For example, a number of node addresses, which point to a number of nodes released by the processor, may be temporarily stored in the local buffer 340 before being written into the tail of the free list 310. The number of nodes may be nodes that have been previously removed from the free list 310 (e.g., the pointer node 312, the non-pointer nodes 320, 322, and 324). Alternatively, the number of nodes may be nodes that have not been included in the free list 310 before. As shown in FIG. 3, after writing four node addresses (with labels 4, 1, 2, and 3) pointing to the pointer node 312 and the non-pointer nodes 320, 322, and 324 into the tail of the free list 310, these four node addresses may be removed from the local buffer 340. In other words, the local buffer 340 may be evicted after each deallocation request. Further, in case the size of the local buffer 340 is insufficient to temporarily hold all node addresses to be added to the free list 310, some node addresses may be stored in other storage spaces that may be available in the memory management unit.

In use, the head of the free list 310 may change after each memory allocation, and tail of the free list 310 may change after each memory deallocation. Therefore, it is possible that any block or node in the memory may at some point end up being the head or the tail of the free list 310. Also, any node in the memory may at some point be a pointer node or a non-pointer node. In the present disclosure, manipulation of node addresses as described above may allow a node to be any node in the free list 310. Furthermore, although only one free list 310 is illustrated in the memory management scheme 300, more than one free list may be used in a disclosed memory management scheme. Multiple free lists may comprise a same or different number of pointer nodes and/or non-pointer nodes. Also, multiple free lists may comprise a same or different size of nodes. In different free lists, nodes may contain a same or different number of sections, and each section may have a same or different size.

Compared with the traditional memory management scheme 100, which may only allocate or deallocate one node with one request, the disclosed memory management scheme 300 may allocate or deallocate a plurality of nodes with one request. As a result, memory allocation and deallocation may be executed faster in the memory management scheme 300. Effective memory bandwidth is increased, or in other words, a requirement of memory bandwidth to fulfill a certain hardware/software feature is lowered, which may lead to cost reduction. This improvement may lead to performance boost in, e.g., dynamic RAM (DRAM) where the memory nodes may be large in size (e.g., 32B or higher). In a DRAM, if free nodes are 32B and a pointer is 4B, then eight node addresses pointing to eight free nodes may be contained within one node. The eight free nodes may be allocated or deallocated with a single request, thereby reducing the memory bandwidth requirement by 8-fold. Consequently, memory management performance may be boosted which leads to higher throughput and lower latency. Also, power consumption of the system may be reduced as a result of the reduced number of read and write operations in the memory. Furthermore, these benefits come at no cost of additional memory space.

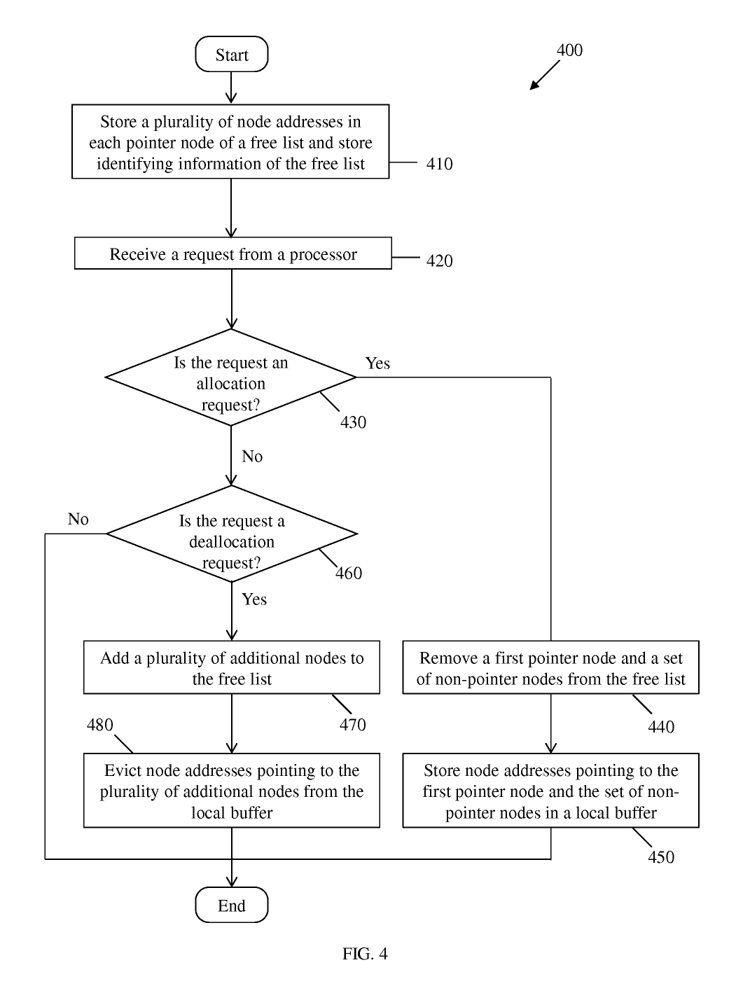

FIG. 4 is a flowchart of an embodiment of a memory management method 400, which may be implemented in a processor system (e.g., the processor system 200 in FIG. 2). The method 400 may start in step 410, where a plurality of node addresses may be stored in each pointer node of a free list, which may be located in a memory (e.g., the memory 230 in FIG. 2). One of the plurality of node addresses may point to another pointer node of the free list, and the rest of the plurality of node addresses may point to at least one non-pointer node. The free list may comprise a last pointer node, in which null addresses or no address may be stored. Further, identifying information of the free list may also be stored, e.g., in the memory management unit 220 in FIG. 2. The identifying information may contain a head (i.e., a first pointer node of the free list), tail (i.e., a last pointer node of the free list), and/or length of the free list. Thus, the free list is identifiable via the identifying information.

Next, in step 420, the method 400 may receive a request, which may be generated by, e.g., a running application in the processor 210 in FIG. 2. Next, in step 430, the method 400 may determine if the request is an allocation request. If the condition in the block 430 is met, the method 400 may proceed to step 440. Otherwise, the method 400 may proceed to step 450. In response to receiving the allocation request, in step 440, the first pointer node as well as a set of non-pointer nodes pointed to by the first pointer node may be removed the free list. In an embodiment, removal of the first pointer node is realized by changing the head of the free list from the first pointer node to a second pointer node of the free list. To change the head, in the identifying information, a node address of (or pointing to) the first node is replaced by a node address of the second pointer node. After being removed from the free list, the first pointer node and the set of non-pointer nodes may be allocated to the running application in the processor. Next, in step 450, the node address of the first node as well as a set of node addresses of (or pointing to) the set of non-pointer nodes may be stored in a local buffer (e.g., the local buffer 224) located in the memory management unit. These node addresses may be stored temporarily to facilitate future deallocation.

In step 460, the method 400 may determine if the request is a deallocation request. If the condition in the block 460 is met, the method 400 may proceed to step 470. Otherwise, the method 400 end. In response to receiving the deallocation request, in step 470, a plurality of additional nodes may be added to the free list. In an embodiment, adding the plurality of additional nodes may be realized by writing node addresses of (or pointing to) the plurality of additional nodes in the last pointer node of the free list. If the node addresses of the plurality of additional nodes have been stored in the local buffer, next in step 480, the node addresses may be removed or evicted from the local buffer. Eviction of the local buffer may leave room for temporary storage of other allocated nodes. It should be noted that, if the node addresses of the plurality of additional nodes have not been stored in the local buffer, they may also be directly written into the last pointer node of the free list. In other words, step 480 may sometimes be skipped, if so desired. After deallocation of the additional nodes, the method 400 may end.

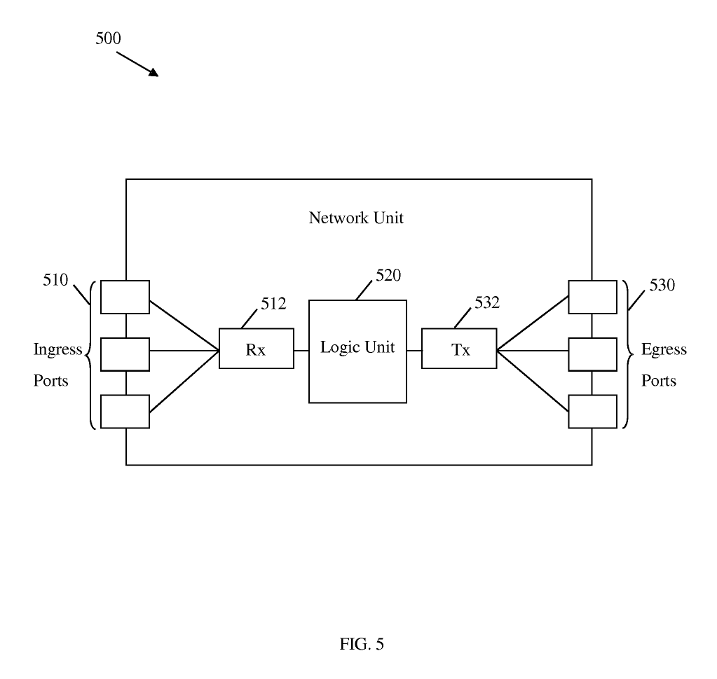

FIG. 5 illustrates a schematic diagram of an embodiment of a network unit 500, which may comprise a processor or a memory management unit that allocates and deallocates memory as described above, for example, within a network or system. The network unit 500 may comprise a plurality of ingress ports 510 and/or receiver units (Rx) 512 for receiving data from other network units or components, logic unit or processor 520 to process data and determine which network unit to send the data to, and a plurality of egress ports 530 and/or transmitter units (Tx) 532 for transmitting data to the other network units. The logic unit or processor 520 may be configured to implement any of the schemes described herein, such as the free list-based memory management scheme 300 and the memory management method 400, and may be implemented using hardware, software, or both.

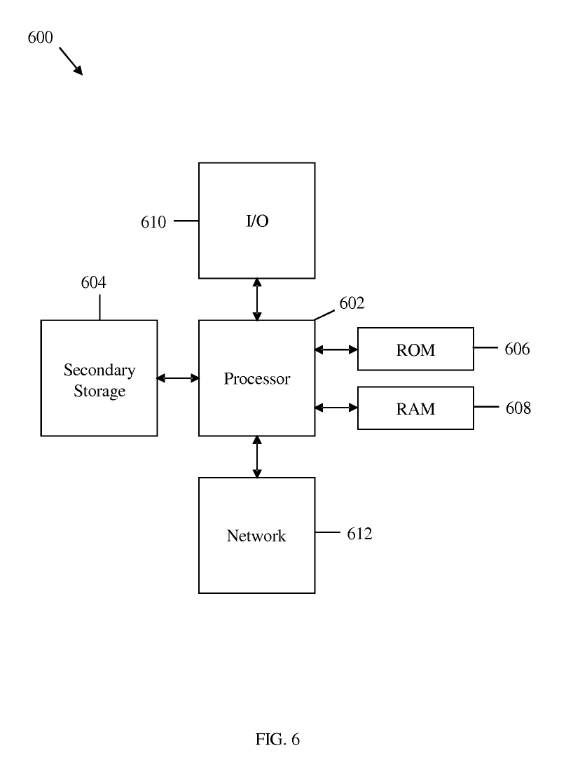

The schemes described above may be implemented on any general-purpose network component, such as a computer or network component with sufficient processing power, memory resources, and network throughput capability to handle the necessary workload placed upon it. FIG. 6 illustrates a schematic diagram of a typical, general-purpose network component or computer system 600 suitable for implementing one or more embodiments of the methods disclosed herein, such as the free list-based memory management scheme 300 and the memory management method 400. The general-purpose network component or computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. Although illustrated as a single processor, the processor 602 is not so limited and may comprise multiple processors. The processor 602 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. The processor 602 may be configured to implement any of the schemes described herein, including the free list-based memory management scheme 300 and the memory management method 400, which may be implemented using hardware, software, or both.

The secondary storage 604 is typically comprised of one or more disk drives or tape drives and is used for non-volatile storage of data and as an over-flow data storage device if the RAM 608 is not large enough to hold all working data. The secondary storage 604 may be used to store programs that are loaded into the RAM 608 when such programs are selected for execution. The ROM 606 is used to store instructions and perhaps data that are read during program execution. The ROM 606 is a non-volatile memory device that typically has a small memory capacity relative to the larger memory capacity of the secondary storage 604. The RAM 608 is used to store volatile data and perhaps to store instructions. Access to both the ROM 606 and the RAM 608 is typically faster than to the secondary storage 604.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, units, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a memory configured to store a free list comprising a plurality of nodes, wherein at least one of the plurality of nodes is configured to store a plurality of node addresses, and wherein each of the plurality of node addresses corresponds to one node in the plurality of nodes.

2. The apparatus of claim 1, wherein each of the plurality of nodes is one of two types: pointer node and non-pointer node, wherein one of the plurality of node addresses points to one pointer node, and wherein the rest of the plurality of node addresses point to at least one non-pointer node.

3. The apparatus of claim 2, wherein each of the at least one of the plurality of nodes comprises a plurality of sections, wherein the plurality of sections include a first section and at least one other section, wherein the one of the plurality of node addresses is stored in the first section, and wherein the rest of the plurality of node addresses are stored in the at least one other section.

4. The apparatus of claim 3, wherein a number of the plurality of sections equals a number of the plurality of node addresses.

5. The apparatus of claim 4, wherein the number of the plurality of sections is four.

6. The apparatus of claim 3, wherein the at least one of the plurality of nodes includes a first pointer node and a second pointer node, wherein the first pointer node is a head of the free list, wherein the first pointer node is configured to store a set of node addresses, wherein one of the set of node addresses points to the second pointer node, wherein the rest of the set of node addresses point to a set of non-pointer nodes, the apparatus further comprising:
a memory management unit coupled to the memory and configured to:
receive an allocation request from a processor; and
in response to receiving the allocation request,
allocate the first pointer node and the set of non-pointer nodes to the processor by removing the first pointer node and the set of non-pointer nodes from the free list.

7. The apparatus of claim 6, wherein the memory management unit is configured to store identifying information, wherein the free list is identifiable by the identifying information, wherein prior to removing the first pointer node and the set of non-pointer nodes, the identifying information comprises a node address of the first pointer node, and wherein removing the first pointer node and the set of non-pointer nodes includes changing the node address of the first pointer node to the node address of the second pointer node.

8. The apparatus of claim 6, wherein the memory management unit is further configured to:
receive a deallocation request from the processor; and
in response to receiving the deallocation request,
add a plurality of additional nodes to the free list, wherein the plurality of additional nodes are indicated by the deallocation request.

9. The apparatus of claim 8, wherein the at least one of the plurality of nodes further includes a last pointer node, wherein the last pointer node is a tail of the free list, wherein a plurality of additional node addresses point to the plurality of additional nodes, and wherein adding the plurality of additional nodes includes writing the plurality of additional node addresses to the last pointer node.

10. The apparatus of claim 9, wherein the memory management unit is configured to store identifying information, wherein the free list is identifiable by the identifying information, wherein prior to adding the plurality of additional nodes, the identifying information comprises a node address of the last pointer node, wherein one of the plurality of additional node addresses is written in a first section of the last pointer node, and wherein adding the plurality of additional nodes further includes changing the node address of the last pointer node to the one of the plurality of additional node addresses.

11. The apparatus of claim 9, wherein the memory management unit comprises a local buffer, wherein the local buffer is configured to:
in response to receiving the allocation request, store the set of node addresses after removing the first pointer node and the set of non-pointer nodes from the free list.

12. The apparatus of claim 11, wherein the local buffer is further configured to:
in response to receiving the deallocation request:
prior to adding the plurality of additional nodes, store the plurality of additional node addresses; and
after adding the plurality of additional nodes, evict the plurality of additional node addresses.

13. The apparatus of claim 12, wherein the plurality of nodes are of one size, and wherein a size of the local buffer is at least two times of the one size.

14. The apparatus of claim 12, wherein the memory is a buffer.

15. A method of memory management comprising:
using a free list comprising a plurality of nodes; and
storing a plurality of node addresses in at least one of the plurality of nodes, and wherein each of the plurality of node addresses corresponds to one node in the plurality of nodes.

16. The method of claim 15, wherein each of the plurality of nodes is one of two types: pointer node and non-pointer node, wherein one of the plurality of node addresses points to one pointer node, and wherein the rest of the plurality of node addresses point to at least one non-pointer node.

17. The method of claim 16, wherein each of the at least one of the plurality of nodes comprises a plurality of sections, wherein the plurality of sections include a first section and at least one other section, wherein the one of the plurality of node addresses is stored in the first section, and wherein the rest of the plurality of node addresses are stored in the at least one other section.

18. The method of claim 17, wherein a number of the plurality of sections equals a number of the plurality of node addresses.

19. The method of claim 18, wherein the number of the plurality of sections is four.

20. The method of claim 17, wherein the at least one of the plurality of nodes includes a first pointer node and a second pointer node, wherein the first pointer node is a head of the free list, wherein the first pointer node is configured to store a set of node addresses, wherein one of the set of node addresses points to the second pointer node, wherein the rest of the set of node addresses point to a set of non-pointer nodes, the method further comprising:
receiving an allocation request from a processor; and
in response to receiving the allocation request,
allocating the first pointer node and the set of non-pointer nodes to the processor by removing the first pointer node and the set of non-pointer nodes from the free list.

21. The method of claim 20, further comprising:
storing identifying information in a memory management unit, wherein the free list is identifiable by the identifying information, wherein prior to removing the first pointer node and the set of non-pointer nodes, the identifying information comprises a node address of the first pointer node, and wherein removing the first pointer node and the set of non-pointer nodes includes changing the node address of the first pointer node to the node address of the second pointer node.

22. The method of claim 20, further comprising:
receiving a deallocation request from the processor; and
in response to receiving the deallocation request,
adding a plurality of additional nodes to the free list, wherein the plurality of additional nodes are indicated by the deallocation request.

23. The method of claim 22, wherein the at least one of the plurality of nodes further includes a last pointer node, wherein the last pointer node is a tail of the free list, wherein a plurality of additional node addresses point to the plurality of additional nodes, and wherein adding the plurality of additional nodes includes writing the plurality of additional node addresses to the last pointer node.

24. The method of claim 23, further comprising:
storing identifying information in a memory management unit, wherein the free list is identifiable by the identifying information, wherein prior to adding the plurality of additional nodes, the identifying information comprises a node address of the last pointer node, wherein one of the plurality of additional node addresses is written in a first section of the last pointer node, and wherein adding the plurality of additional nodes further includes changing the node address of the last pointer node to the one of the plurality of additional node addresses.

25. The method of claim 23, further comprising:
in response to receiving the allocation request, storing the set of node addresses in a local buffer after removing the first pointer node and the set of non-pointer nodes from the free list.

26. The method of claim 25, further comprising:
in response to receiving the deallocation request:
prior to adding the plurality of additional nodes, storing the plurality of additional node addresses in the local buffer; and
after adding the plurality of additional nodes, evicting the plurality of additional node addresses from the local buffer.

27. The method of claim 26, wherein the plurality of nodes are of one size, and wherein a size of the local buffer is at least two times of the one size.

28. The method of claim 26, wherein the memory is a buffer.

29. An apparatus comprising:
a memory configured to store a free list, wherein the free list comprises a plurality of nodes including a first pointer node, a second pointer node, and a set of non-pointer nodes, wherein the first pointer node is configured to store a set of node addresses, wherein one of the set of node addresses points to the second pointer node, and wherein the rest of the set of node addresses point to corresponding ones of the set of non-pointer nodes;
a processor coupled to the memory and configured to generate an allocation request; and
a memory management unit coupled to the memory and configured to:
store identifying information of the free list, wherein the identifying information comprises a node address of the first pointer node;
in response to the allocation request,
remove the first pointer node and the corresponding ones of the set of non-pointer nodes from the free list by changing the node address of the first pointer node to a node address of the second pointer node; and
store the node address of the first pointer node and the rest of the set of node addresses in a local buffer.

30. The apparatus of claim 29, wherein the plurality of nodes further includes a last pointer node, wherein the processor is further configured to generate a deallocation request after the allocation request, wherein the memory management unit is further configured to:
in response to the deallocation request,
add the first pointer node and the corresponding ones of the set of non-pointer nodes back to the free list by writing the node address of the first pointer node and the rest of the set of node addresses to the last pointer node; and
evict the node address of the first pointer node and the rest of the set of node addresses from the local buffer.
